(19) United States
(12) Patent Application Publication
(10) Pub. No.: US 2015/0027944 A1
(43) Pub. Date: Jan. 29, 2015

(54) METHOD AND APPARATUS FOR SEALING MECHANISMS FOR USE WITH CARTRIDGE-BASED FILTRATION SYSTEMS

(71) Applicant: Charles W. Mitsis, Scottsdale, AZ (US)

(72) Inventor: Charles W. Mitsis, Scottsdale, AZ (US)

(21) Appl. No.: 13/952,597

(22) Filed: Jul. 27, 2013

(51) Int. Cl. C02F 1/00

(52) U.S. Cl. CPC C02F 1/003
USPC 210/450; 29/428

(57) ABSTRACT

A filtration cartridge of a cartridge-based filtration system is provided that includes annular ring arrangements on one or more end caps and the shell of the filtration cartridge. Once engaged, the annular ring arrangements form a coefficient of friction between the end cap(s) and the shell to create a substantially water-tight seal between the end cap(s) and the shell of the filtration cartridge. Annular locking arrangements may be included in addition to, or in lieu of, the annular ring arrangements to lock the end cap(s) to the shell when the filtration cartridge is utilized in high-pressure applications.

### FIELD OF THE INVENTION

The present invention generally relates to filtration systems, and more particularly to sealing mechanisms utilized within a cartridge-based filtration system.

### BACKGROUND

Filtration systems may be used in various applications where certain contaminants contained within a liquid (e.g., water) are removed before the liquid is considered to be ready for use. Water treatment systems, for example, may utilize one or more stages of filtration to successively remove contaminants (e.g., suspended solids and total dissolved solids) from an inlet water supply before being used for a particular application (e.g., drinking water or fresh/salt water aquariums).

Cartridge filters may, for example, be utilized in fluid treatment systems, where the cartridge filters may be designed to remove contaminants from a fluid (e.g., water) using one or more types of filtration media, such as fabric, polymer, carbon, or resin-based filtration media to name only a few. A single-cartridge filtration system may be used, for example, when the inlet water is derived from a relatively high-quality source and only relatively large-sized contaminants (e.g., sediment) are desired to be removed. Multiple-cartridge filtration systems may be used, for example, to filter the inlet water through a progression of cartridge filters containing filtration media that progressively remove contaminants in stages (e.g., sediment removal in a first stage, chlorine removal in a second stage and total dissolved solids removal in third and subsequent stages). Accordingly, filtered water may emerge from the multiple-cartridge filtration system that contains very few contaminates (e.g., sub-micron sized contaminates).

One or more cartridge filters may be contained within a housing of a cartridge-based filtration system. The housing may, for example, force un-filtered water to flow on the outside of the cartridge to an inlet port of the cartridge, while filtered water may be forced to flow from within the cartridge to an outlet port of the cartridge. Accordingly, the cartridges may be manufactured to be substantially water tight, whereby only the inlet port and the outlet port allow passage of water.

Components of a cartridge may include a shell (e.g., a cylindrically-shaped plastic shell) to house the filtration media. A top portion (e.g., a plastic lid) and a bottom portion (e.g., a plastic base) may be attached to the shell to seal the filtration media within the shell. The bottom portion may include an inlet port to allow un-filtered water to flow through the filtration media, while the top portion may include an outlet port to allow filtered water to flow from the filtration media.

Plastic welding techniques may be conventionally employed to seal the top and bottom portions to the shell. A conventional ultrasonic welding technique may, for example, use high-frequency (e.g., 15 kHz to 40 kHz) low-amplitude vibration to create heat by way of friction. Ultrasonic welding, while expeditious, requires specialized equipment that may be cost prohibitive in some instances. Other conventional welding techniques may include spin welding, whereby one piece (e.g., the shell) is held stationary, while a second piece (e.g., one of the top or bottom portions) is rotated at high velocity while in slight contact with the shell to create heat through friction. Spin welding, however, may establish a height dimension of the cartridge that may exhibit a wide range of variability due to the imprecise nature of the technique. In addition, spin welding may introduce undesirable by-products (e.g., bits of molten plastic) within the shell.

Efforts continue, therefore, to develop inexpensive techniques to create water-tight joints for cartridge-based filtration systems that may yield cartridge dimensions that consistently meet tolerance restrictions.

### SUMMARY

To overcome limitations in the prior art, and to overcome other limitations that will become apparent upon reading and understanding the present specification, various embodiments of the present invention disclose methods and apparatus for sealing mechanisms used in the formation of a cartridge for a cartridge-based filtration system. The sealing mechanisms may employ annular ring arrangements, whereby a first annular ring arrangement (e.g., a female and male annular ring) may exist on a first component of the cartridge and a second annular ring arrangement (e.g., a female and male annular ring) may exist on a second component of the cartridge. Pressing the first and second components together may cause portions (e.g., male and female portions) of the first and second annular ring arrangements to engage each other.

Once engaged, a coefficient of friction may exist between the first and second components that resists relative rotational movement between the first and second components as well as relative longitudinal movement between the first and second components. Accordingly, for example, a seal may be formed after the portions of each annular ring arrangement of the first and second components engage one another. In so doing, for example, filtration media may first be inserted into a shell and a top and/or a bottom portion may be “snap fitted” to the shell to seal the filtration media within the shell to form a filtration cartridge of a cartridge-based filtration system.

In addition, sufficient compression and frictional forces may exist along the entire circumference of the annular ring arrangements, such that a substantially water-tight seal may be formed between the cartridge shell and the top and/or bottom portions of the cartridge. Accordingly, passage of water into and from the cartridge may be limited exclusively to the inlet port and the outlet port, respectively, of the cartridge without engaging any form of welding technique (e.g., plastic welding technique) to establish the substantially water-tight seal.

Additionally, by aligning the first annular ring arrangement to a specific location on the first component of the cartridge and by aligning the second annular ring arrangement to a specific location on the second component of the cartridge, a dimension (e.g., height) of the filtration cartridge may be controlled to within tight tolerances. In so doing, the cartridge may more precisely fit within a cartridge-based filtration system component (e.g., a housing) to facilitate an optimized compression-based interface between the cartridge and the housing.

In high-pressure applications, an annular locking mechanism may be employed within a filtration cartridge in addition to, or in lieu of, an annular ring arrangement. Once the annular locking mechanism of a first component of the cartridge engages the annular locking mechanism of a second component of the cartridge, a high-pressure, substantially water-tight seal may be formed for optimal performance of the filtration cartridge when used in high-pressure applications, such as whole house water filtration systems, hydraulic fluid filtration systems and fuel filtrations systems.

In accordance with one embodiment of the invention, a filtration system comprises at least one filtration cartridge and at least one housing encapsulating the at least one filtration cartridge. The at least one filtration cartridge includes a lid having a first annular ring arrangement and a shell having a second annular ring arrangement. The first and second annular ring arrangements engage each other to seal the lid to the shell.

In accordance with another embodiment of the invention, a method of assembling a filtration cartridge comprises providing an annular ring arrangement on a lid of the filtration cartridge, providing an annular ring arrangement on a shell of the filtration cartridge and engaging the annular ring arrangements of the lid and shell to seal the lid to the shell.

In accordance with another embodiment of the invention, a filtration system comprises at least one filtration cartridge and at least one housing encapsulating the at least one filtration cartridge. The at least one filtration cartridge includes a lid having a first annular ring arrangement and a first annular locking arrangement and a shell having a second annular ring arrangement and a second locking arrangement. The first and second annular ring arrangements engage each other to seal the lid to the shell and the first and second annular locking arrangements engage each other to lock the lid to the shell.

### BRIEF DESCRIPTION OF THE DRAWINGS

Various aspects and advantages of the invention will become apparent upon review of the following detailed description and upon reference to the drawings in which:

FIG. 1 illustrates a multiple-cartridge filtration system in accordance with one embodiment of the present invention;

FIG. 2 illustrates a filtration cartridge and housing of a single or multiple-cartridge filtration system in accordance with one embodiment of the present invention;

FIG. 3 illustrates annular ring arrangements of a filtration cartridge in accordance with one embodiment of the present invention;

FIG. 4 illustrates an annular locking mechanism of a filtration cartridge in accordance with one embodiment of the present invention; and

FIG. 5 illustrates methods of assembling a filtration cartridge in accordance with the various embodiments of the present invention.

### DETAILED DESCRIPTION

Generally, the various embodiments of the present invention are applied to single or multiple cartridge-based filtration systems. One or more of the cartridges of the cartridge-based filtration systems may be formed of a material (e.g., semi-rigid plastic or stainless steel) having a shell (e.g., a cylindrically-shaped shell) with end caps on both ends of the shell. Each end cap may, for example, include a port that may allow the passage of a liquid (e.g., water) into and away from the shell.

One or both of the cartridge end caps may be formed with an annular ring arrangement (e.g., a convex annular ring and a concave annular ring) that may extend around an entire outer circumference of the end cap. One or both ends of the cartridge shell may be formed with an annular ring arrangement (e.g., a convex annular ring and a concave annular ring) that extend around an entire inner circumference of the shell. An outer circumference of the end cap may be slightly smaller than the inner circumference of the cartridge shell, such that the end cap may be initially positioned within the shell and then pressed into the cartridge shell.

As the end cap is pressed into the cartridge shell, the convex annular ring of the end cap may initially engage the convex annular ring of the cartridge shell. An increase in the force used to press the cap into the cartridge shell may cause the cartridge shell to slightly expand and/or may cause the end cap to slightly compress, such that the convex annular ring of the end cap may slide past the convex annular ring of the cartridge shell. Once the end cap is engaged to the cartridge shell, the convex annular ring of the end cap may “snap” into the groove formed by the concave annular ring of the cartridge shell. Likewise, the convex annular ring of the cartridge shell may “snap” into the groove formed by the concave annular ring of the end cap.

Once engaged, a coefficient of friction may exist between the end cap and the cartridge shell, such that rotational and longitudinal movement of the end cap within the cartridge shell may be restricted. In addition, a compression force may exist between the end cap and the cartridge shell to form a substantially water-tight seal between the end cap and the cartridge shell, such that water egress from the shell and water ingress into the shell is substantially limited to the inlet and outlet ports of the respective end caps.

The annular ring arrangement of the cartridge shell and the annular ring arrangement of the end caps may be precisely aligned to each other. Accordingly, for example, completed cartridges (e.g., cartridge shells encompassing filtration media that are sealed on both ends by end caps) may consistently exhibit dimensions (e.g., length dimensions) that may be precisely controlled within tight tolerances. Accordingly, the completed cartridges may precisely fit within other filtration system components (e.g., housings) such that the engagement mechanisms (e.g., compression-based engagement mechanisms) between the filtration cartridges and their respective housings may be optimally aligned and positioned.

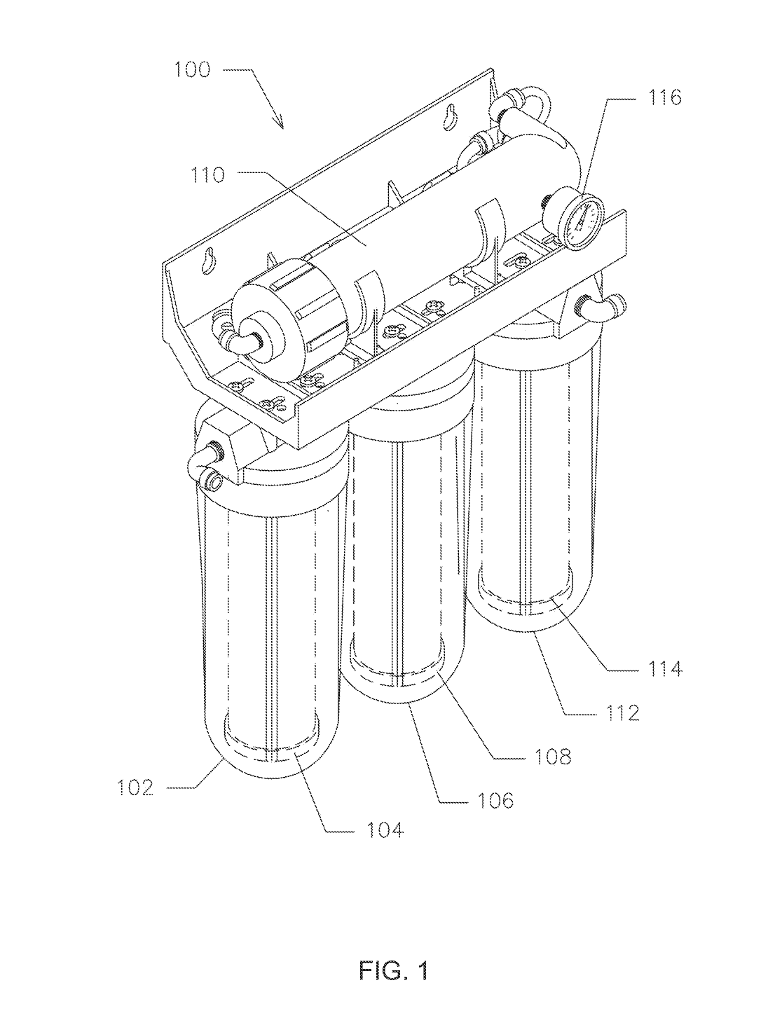

Turning to FIG. 1, multiple-cartridge filtration system 100 is exemplified, where a first stage of multiple-cartridge water filtration system 100 may, for example, include a mechanical filtration mechanism (e.g., filtration cartridge 104 including pleated cellulose media sealed within housing 102) to remove solid particulates (e.g., sediment) from the inlet water before the inlet water is passed on to a second stage of water filtration. A second stage of a multiple-cartridge water filtration system may, for example, include carbon-based media (e.g., filtration cartridge 108 including activated charcoal sealed within housing 106) to remove contaminants (e.g., chlorine and chloramines) that may cause the water to exhibit unwanted odor, color and taste characteristics. Further, chlorine may be removed to protect the membrane (e.g., a semi-permeable membrane) of a third stage of water filtration.

A third stage of a multiple-cartridge water filtration system may, for example, include a semi-permeable membrane 110 that may allow water molecules to pass through the membrane, while the membrane rejects most other contaminants. Most of the total dissolved solids (TDSs) (e.g., between approximately 96% and 98% of the TDSs) may, for example, be removed by semi-permeable membrane 110. A fourth stage of a multiple-cartridge water filtration system may, for example, include ion exchange media (e.g., deionization resin 114 sealed within housing 112) where the vast majority of the remaining total dissolved solids may be removed by a deionization process. It is understood that subsequent purification stages (e.g., subsequent deionization stages) may be added/removed to/from multiple-cartridge water filtration system 100 as may be required by a particular application.

A multiple-cartridge water filtration system may, for example, also include pressure gauge 116 to help determine when a filtration cartridge (e.g., sediment cartridge 104) should be replaced. Accordingly, for example, a housing (e.g., housing 102) may be removed (e.g., unscrewed) from multiple-cartridge water filtration system 100 and a cartridge (e.g., cartridge 104) may be replaced within housing 102 and housing 102 may be subsequently re-attached to multiple-cartridge water filtration system 100. A multiple-cartridge water filtration system may, for example, also include one or more TDS meters (not shown) so as to facilitate measurement of the effectiveness of the TDS filtration stages (e.g., semi-permeable membrane 110 and deionization cartridge 114) to determine a subsequent need for replacement of one or more of the TDS filtration stages.

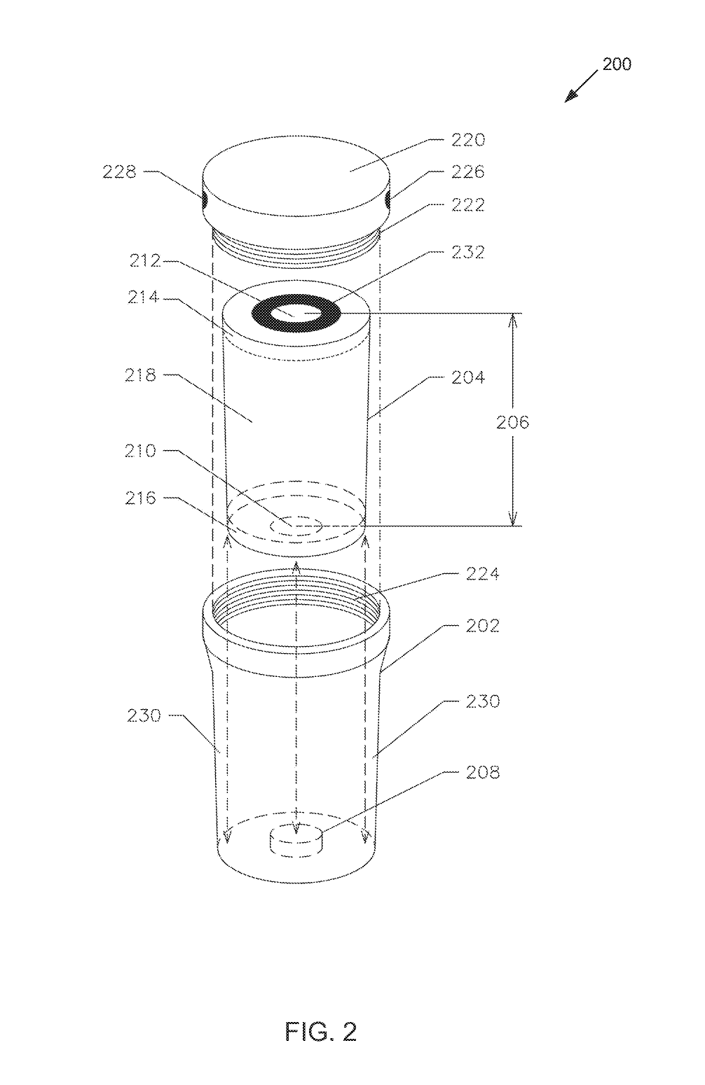

Turning to FIG. 2, assembly 200 may include filtration cartridge 204 and an associated housing (e.g., vessel 202 and lid 220) of a single or multiple-cartridge filtration system. Filtration cartridge 204 may exhibit an outside circumference that may be smaller than an inside circumference of vessel 202. Accordingly, for example, once cartridge 204 is inserted into vessel 202 and once lid 220 is secured to vessel 202, thereby encapsulating cartridge 204 within its associated housing, region 230 may exist to allow un-filtered water to flow from inlet port 226 of lid 220 to inlet port 210 of filtration cartridge 204.

Lid 220 may exhibit a threaded portion (e.g., male-threaded portion 222) that may engage a threaded portion (e.g., female-threaded portion 224) of vessel 202. Once fully engaged, inlet port 226 of lid 220 may be in fluidic communication with region 230, such that filtration cartridge 204 may accept unfiltered water from inlet port 226 and inlet port 210 via region 230. Additionally, outlet port 212 of cartridge 204 may be in fluidic communication with outlet port 228 of lid 220, such that filtered water may be allowed to exit outlet port 212 of filtration cartridge 204 to outlet port 228 of lid 220.

Vessel 202 may further include a guide (e.g., pedestal 208) to facilitate proper positioning of filtration cartridge 204 within vessel 202. Once filtration cartridge 204 is positioned within vessel 202 via guide 208, threaded portion 224 of vessel 202 may engage threaded portion 222 of lid 220 to secure filtration cartridge 204 within the housing (e.g., filtration cartridge 204 is encapsulated within the combination of lid 220 and vessel 202). A gasket (e.g.. gasket 232) surrounding outlet port 212 may engage a seat (not shown) within lid 220, such that water exiting outlet port 212 may be forced to flow into outlet port 228, while water entering inlet port 226 may be forced to flow into inlet port 210 via region 230 in order to avoid a bypass condition.

Filtration cartridge 204 may include a shell (e.g., shell portion 218), a first end cap (e.g., cap 214) and a second end cap (e.g., cap 216). Cap 214 may include a water passage port (e.g., outlet port 212) and cap 216 may include a water passage port (e.g., inlet port 210). Filtration cartridge 204 may exhibit a dimension (e.g., height 206) that may include, for example, the height of shell 218, the height of cap 214 and the height of cap 216. Height 206 may, for example, be controlled within tight tolerances, such that once lid 220 is secured to vessel 202, an optimal compression force may be exerted on gasket 232 by the seat (not shown) of lid 220 to secure filtration cartridge 204 within vessel 202 and to force a non-bypass, water flow direction from inlet port 226, to region 230, to inlet port 210, to outlet port 212, and to outlet port 228.

It is noted that a reverse-flow operation may be implemented by filtration cartridge 204 and the associated housing (e.g., vessel 202 and lid 220) whereby each port may be reversed in operation. In particular, inlet port 228 of lid 220 may be in fluidic communication with inlet port 212 of cartridge 204, such that filtration cartridge 204 may accept unfiltered water from inlet port 228 and inlet port 212. Additionally, outlet port 210 of cartridge 204 may be in fluidic communication with region 230 and outlet port 226 of lid 220, such that filtered water may be allowed to exit outlet port 210 of filtration cartridge 204 to outlet port 226 of lid 220 via region 230.

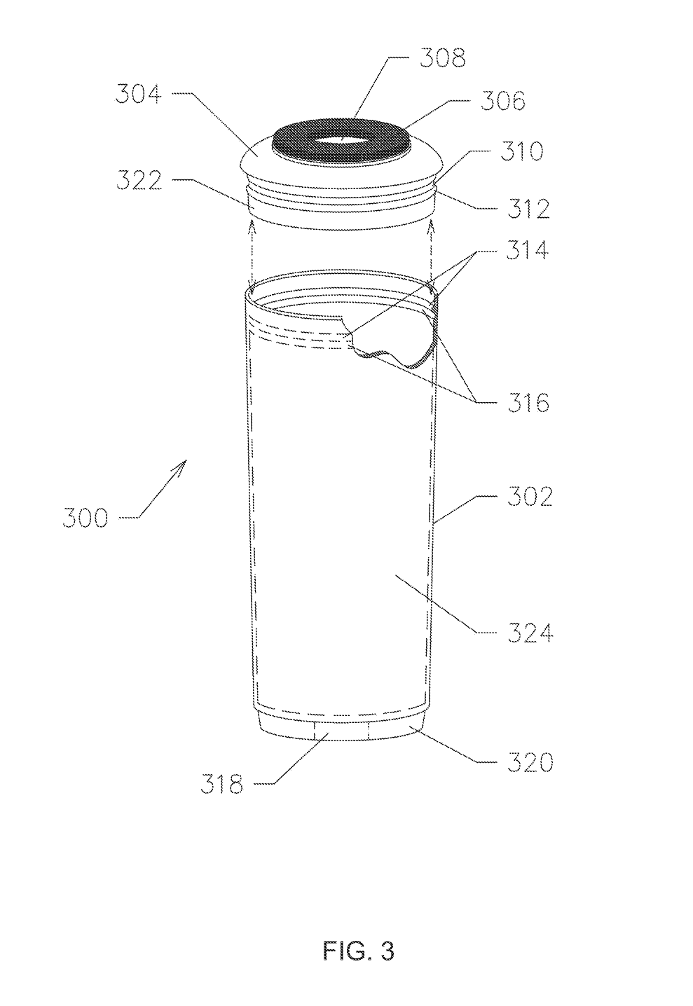

Turning to FIG. 3, annular ring arrangements of filtration cartridge 300 are exemplified. An annular ring arrangement may be provided on a portion (e.g., outer portion 322) of an end cap (e.g., cap 304) of filtration cartridge 300 such that annular concave ring 310 may exist in proximity to annular convex ring 312. Similarly, an annular ring arrangement may be provided on an inner portion of filtration cartridge 300 (e.g., shell 302) such that annular concave ring 316 may exist in proximity to annular convex ring 314 (e.g., as exemplified by the break-away cross-section of FIG. 3 shown for illustration purposes only). Once cap 304 and shell 302 are fully engaged (e.g., portion 322 of cap 304 is fully inserted into shell 302), it can be seen that the annular ring arrangement of cap 304 fully engages the annular ring arrangement of shell 302. In particular, for example, annular concave ring 310 may encapsulate at least a portion of annular convex ring 314 around an entire circumference of portion 322, while annular concave ring 316 may encapsulate at least a portion of annular convex ring 312 around an entire circumference of cap portion 322.

As cap 304 is inserted into shell 302, convex annular ring 312 of cap 304 may engage the inside contour of shell 302. Likewise, convex annular ring 314 of shell 302 may engage outer portion 322. A semi-rigid characteristic of shell 302 and/or cap 304 may allow for expansion and/or compression as cap 304 is inserted into shell 302, so as to allow the annular ring arrangement of cap 304 to fully engage the annular ring arrangement of shell 302.

It should be noted that the numbers of and positions of the annular convex and/or concave rings of the annular ring arrangements of shell 302 and cap 304 may be increased/altered to any number/position as may be required by a particular application. For example, a single convex/concave ring may be provided on cap while a corresponding single concave/convex ring may be provided on shell 302. As per another example, three convex/concave rings may be provided on cap 304 while corresponding three concave/convex rings may be provided on shell 302. It is further noted, however, that the position of any convex ring of an annular ring arrangement should align with the position of the corresponding concave ring of the mating annular ring arrangement, such that a coefficient of friction between cap 304 and shell 302 may be optimized (e.g., maximized).

The opposing end cap (e.g., cap 320) may also be attached to shell 302 via engagement of annular ring arrangements. Alternately, for example, cap 320 may be attached to shell 302 via any other method, such as a plastic welding method (e.g., spin welding or ultrasonic welding) provided shell 302 and cap 320 are plastic. Cap 320 may include a port (e.g., inlet port 318) to allow a liquid (e.g., water) to flow into filtration media 324. Cap 304 may include a port (e.g., outlet port 308) to allow a liquid (e.g., water) to flow out of filtration media 324. Gasket 306 may, for example, be included with cap 304 so as to facilitate a compression-based engagement between filtration cartridge 300 and another filtration system component (e.g., a housing for cartridge 300 not shown).

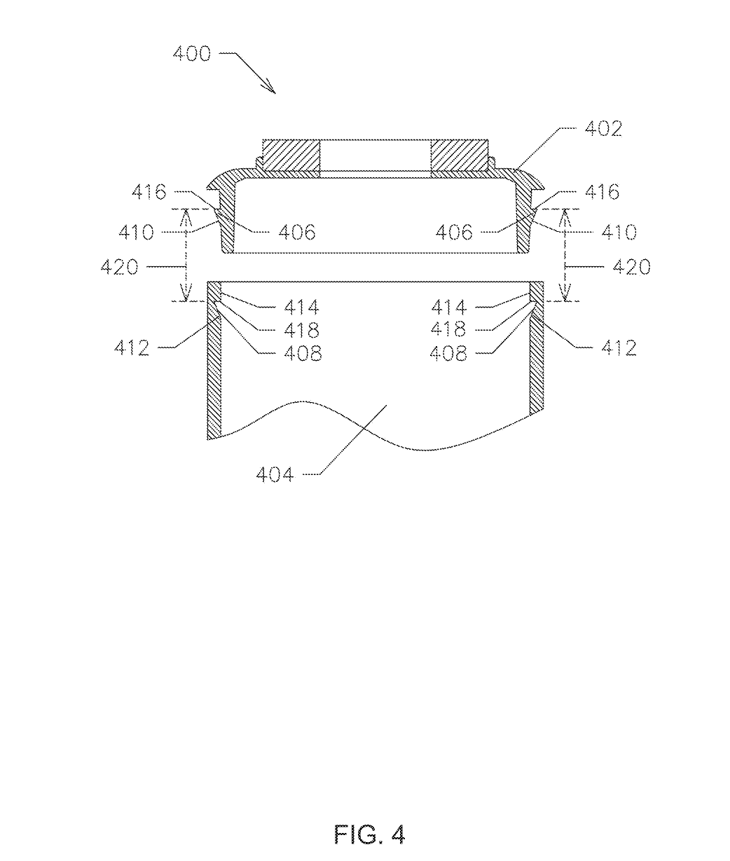

Turning to FIG. 4, annular locking mechanisms of filtration cartridge 400 are exemplified by cross-section view. The annular locking mechanisms of filtration cartridge 400 may be used in addition to, or in lieu of, annular ring arrangements (e.g., the annular ring arrangements of FIG. 3). Cap 402 of filtration cartridge 400 may, for example, include an annular barb 406 having tapered portion 410 and locking portion 416. Shell 404 of filtration cartridge 400 may, for example, include an annular indention 408 having tapered portion 412 and locking portion 418.

As cap 402 is inserted into shell 404, tapered portion 410 of annular barb 406 engages inner sidewall 414 of shell 404. A semi-rigid characteristic of cap 402 and/or shell 404 may allow cap 402 to be fully inserted into shell 404 while tapered portion 410 compresses and/or while inner sidewall 414 expands to allow passage of annular barb 406 along inner sidewall 414. Once cap 402 is fully inserted into shell 404 (e.g., along the direction and magnitude indicated by vector 420), locking portion 416 of annular barb 406 may engage corresponding locking portion 418 of annular indention 408 to secure (e.g., lock) cap 402 onto shell 404. Such an annular locking arrangement may, for example, secure cap 402 onto shell 404 for high-pressure applications, such as whole house water filtration systems, fuel filtration systems, hydraulic filtration systems, etc.

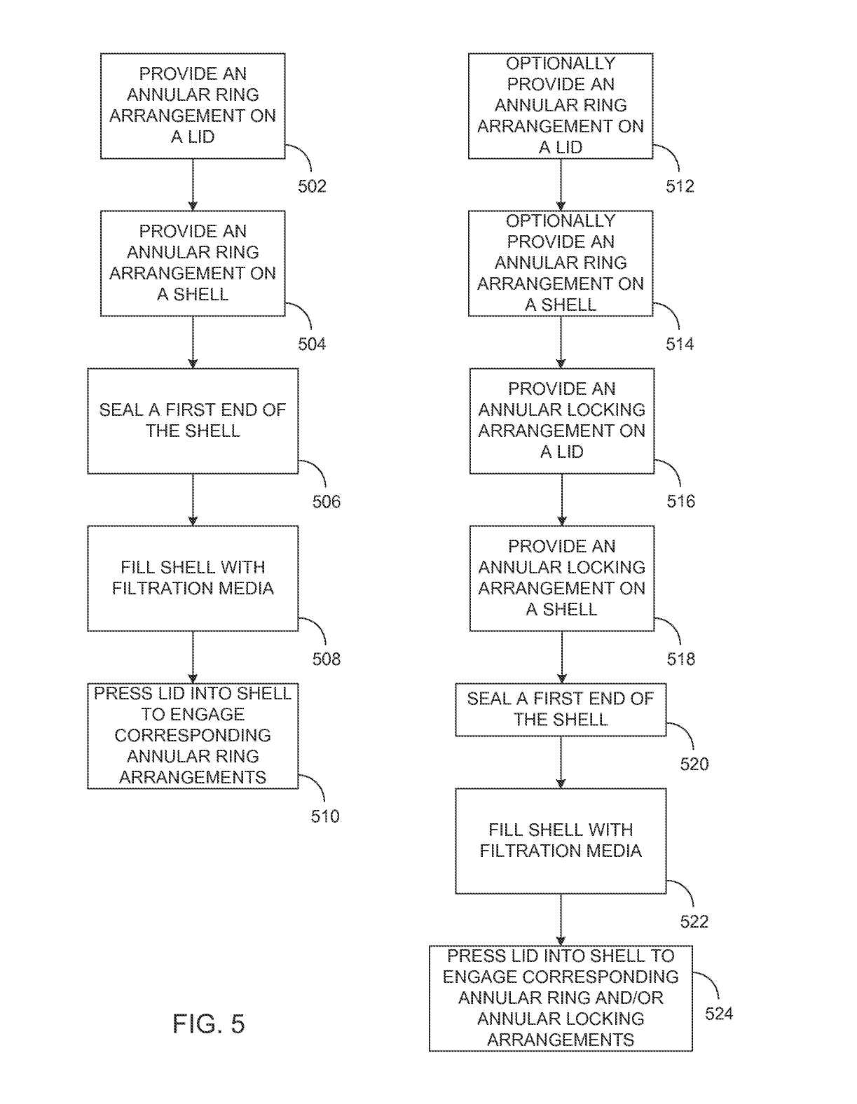

Turning to FIG. 5, methods of assembling filtration cartridges are exemplified. In steps 502 and 504, annular ring arrangements may be provided on a lid and a shell of a filtration cartridge, respectively. An annular ring arrangement may, for example, include an annular convex ring and/or an annular concave ring. A first end of the shell may, for example, be sealed in step 506 using additional annular ring arrangements, or alternately, with other methods. In step 508, filtration media (e.g., fabric, polymer, carbon, or resin-based filtration media) may be inserted into the shell.

The annular ring arrangement of step 502 may, for example, be a mirror image of the annular ring arrangement of step 504, such that the one or more annular convex rings of step 502 may align with the one or more annular concave rings of step 504 and the one or more annular concave rings of step 502 may align with the one or more annular convex rings of step 504 when the annular ring arrangements are engaged with one another to form a substantially water-tight seal as in step 510.

In steps 512 and 514, annular ring arrangements may optionally be provided on a lid and a shell of a filtration cartridge, respectively. An annular ring arrangement may, for example, include an annular convex ring and/or an annular concave ring. In steps 516 and 518, annular locking arrangements may be provided on a lid and a shell of a filtration cartridge, respectively.

A first end of the shell may, for example, be sealed in step 520 with additional annular ring arrangements, or alternately, with other methods. In step 522, filtration media (e.g., fabric, polymer, carbon, or resin-based filtration media) may be inserted into the shell.

The annular ring arrangement of step 512 (if provided) may, for example, be a mirror image of the annular ring arrangement of step 514 (if provided), such that the annular convex ring of step 512 aligns with the annular concave ring of step 514 and the annular concave ring of step 512 aligns with the annular convex ring of step 514 if the annular ring arrangements are engaged with one another to form a substantially water-tight seal as in step 524.

In high-pressure applications, such as with whole house water filtration, hydraulic fluid filtration, fuel filtration, etc., the annular locking mechanisms of steps 516 and 518 may be employed in addition to, or in lieu of, the annular ring arrangements of steps 512 and 514. Once the lid and shell are engaged with one another, the annular locking arrangements of the lid and shell engage to form a substantially permanent relationship to lock the lid and shell together even under high-pressure conditions as in step 524.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. A filtration system, comprising:
at least one filtration cartridge; and
at least one housing encapsulating the at least one filtration cartridge, wherein the at least one filtration cartridge includes,
a lid having a first annular ring arrangement; and
a shell having a second annular ring arrangement, wherein the first and second annular ring arrangements engage each other to seal the lid to the shell.

2. The filtration system of claim 1, wherein the first annular ring arrangement includes an annular convex ring and an annular concave ring.

3. The filtration system of claim 1, wherein the second annular ring arrangement includes an annular convex ring and an annular concave ring.

4. The filtration system of claim 1, wherein the at least one housing includes a second lid having an inlet port and an outlet port.

5. The filtration system of claim 1, wherein the lid includes an outlet port.

6. The filtration system of claim 1, wherein the shell includes an inlet port.

7. A method of assembling a filtration cartridge, comprising:
providing an annular ring arrangement on a lid of the filtration cartridge;
providing an annular ring arrangement on a shell of the filtration cartridge; and
engaging the annular ring arrangements of the lid and shell to seal the lid to the shell.

8. The method of claim 7, wherein providing an annular ring arrangement on the lid includes providing an annular concave ring in proximity to an annular convex ring.

9. The method of claim 8, wherein providing an annular ring arrangement on the shell includes providing an annular concave ring in proximity to an annular convex ring.

10. The method of claim 9, wherein engaging the annular ring arrangements comprises:
encapsulating at least a portion of the annular convex ring of the lid with the annular concave ring of the shell.

11. The method of claim 10, wherein engaging the annular ring arrangements further comprises:
encapsulating at least a portion of the annular convex ring of the shell with the annular concave ring of the lid.

12. The method of claim 7, further comprising:
providing an annular locking arrangement on a lid of the filtration cartridge;
providing an annular locking arrangement on a shell of the filtration cartridge; and
engaging the annular locking arrangements of the lid and shell to lock the lid to the shell.

13. A filtration system, comprising:
at least one filtration cartridge; and
at least one housing encapsulating the at least one filtration cartridge, wherein the at least one filtration cartridge includes,
a lid having a first annular ring arrangement and a first annular locking arrangement; and
a shell having a second annular ring arrangement and a second locking arrangement, wherein the first and second annular ring arrangements engage each other to seal the lid to the shell and the first and second annular locking arrangements engage each other to lock the lid to the shell.

14. The filtration system of claim 13, wherein the first annular ring arrangement includes an annular convex ring and an annular concave ring.

15. The filtration system of claim 13, wherein the second annular ring arrangement includes an annular convex ring and an annular concave ring.

16. The filtration system of claim 13, wherein the at least one housing includes a second lid having an inlet port and an outlet port.

17. The filtration system of claim 13, wherein the lid includes an outlet port.

18. The filtration system of claim 1, wherein the shell includes an inlet port.

19. The filtration system of claim 13, wherein the first annular locking arrangement includes an annular barb having a tapered portion and a locking portion.

20. The filtration system of claim 13, wherein the second annular locking arrangement includes an annular indention having a tapered portion and a locking portion.
